(19) United States
(12) Patent Application Publication
(10) Pub. No.: US 2009/0055181 A1
(43) Pub. Date: Feb. 26, 2009

(54) MOBILE TERMINAL AND METHOD OF INPUTTING MESSAGE THERETO

(75) Inventors: Mi Kyung HAN, Gumi-si (KR); Jae Wan PARK, Gumi-si (KR); Sang Min HAN, Gumi-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si, (KR)

(21) Appl. No.: 12/194,905

(22) Filed: Aug. 20, 2008

(30) Foreign Application Priority Data
Aug. 23, 2007 (KR) 2007-84884

(51) Int. Cl. G10L 15/04

(52) U.S. Cl. 704/251; 704/E15.001

(57) ABSTRACT

A mobile terminal and a method of inputting a message thereto are provided. The method of inputting a message includes analyzing an input voice signal and determining whether the voice signal corresponds to a message modification instruction, and modifying, if the voice signal corresponds to a message modification instruction, a message according to the voice signal. A user can thereby input a message through the input of a voice in the mobile terminal and modify the input message.

### PRIORITY

This application claims the benefit under 35 U.S.C. § 119(a) of a Korean patent application filed in the Korean Intellectual Property Office on Aug. 23, 2007 and assigned Serial No. 2007-0084884, the entire disclosure of which is hereby incorporated by reference.

### BACKGROUND OF THE INVENTION

1. Field of the Invention

The present invention relates to a mobile terminal and a method of inputting a message thereto. More particularly, the present invention relates to a mobile terminal and a method of inputting a message to the mobile terminal using voice recognition.

2. Description of the Related Art

Currently, in addition to providing voice and audiovisual communication functions, a mobile terminal also includes a message function. Using the message function, a user can communicate with another person using a character message. The message function may be a Short Message Service (SMS) function using characters or symbols, a Multimedia Message Service (MMS) function using music and pictures as well as characters and symbols, and an instant message function.

The message function in the mobile terminal has an advantage in that the content of a message that is transmitted or received by a user can be repeatedly viewed. Many users use a message function because of this reason.

When inputting a message in the mobile terminal, the user inputs the message through an input unit thereof such as a keypad or a touch screen. However, because such an input unit of a typical mobile terminal has a small size, a user inputting a message may inadvertently input an unintended character instead of the intended character. Further, a user may experience difficulty in manipulating the keys of the mobile terminal which in turn may require additional time to input a message, thus resulting in user inconvenience.

### SUMMARY OF THE INVENTION

An aspect of the present invention is to address the above-mentioned problems and/or disadvantages and to provide at least the advantages described below. Accordingly, an aspect of the present invention is to provide a mobile terminal and a method of inputting and modifying a message therein.

Another aspect of the present invention is to provide a mobile terminal and a method of inputting and modifying a message using a user's voice.

In accordance with an aspect of the present invention, a method of inputting a message is provided. The method includes analyzing an input voice signal and determining whether the voice signal corresponds to a message modification instruction, and modifying, if the voice signal corresponds to a message modification instruction, a message according to the voice signal.

In accordance with another aspect of the present invention, a mobile terminal is provided. The mobile terminal includes an input unit, an audio processor for receiving a voice signal, a display unit for displaying a message corresponding to the input voice signal and a controller for analyzing the voice signal input through the audio processor, for determining whether the voice signal is a voice signal for modifying a message, for displaying, if the voice signal is not a voice signal for modifying a message, a message according to the voice signal and for modifying, if the voice signal is a voice signal for modifying a message, a message according to the voice signal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating a configuration of a mobile terminal according to an exemplary embodiment of the present invention;

FIG. 2 is a flowchart illustrating a method of inputting a message through voice recognition in a mobile terminal according to an exemplary embodiment of the present invention;

FIG. 3 illustrates an example of a screen displaying a message input window in a mobile terminal in the method of FIG. 2;

FIG. 4 is a flowchart illustrating an exemplary process of performing a message modification function in the method of FIG. 2;

FIGS. 5A and 5B illustrate examples of a screen for adding a word in the process of FIG. 4;

FIGS. 6A and 6B illustrate examples of a screen for deleting a word in the process of FIG. 4;

FIGS. 7A and 7B illustrate examples of a screen for adding another word after deleting a word in the process of FIG. 4;

FIG. 8 is a flowchart illustrating a method of setting a user voice model in a mobile terminal according to an exemplary embodiment of the present invention; and

FIGS. 9A and 9B illustrate examples of a screen for setting the user voice model in the method of FIG. 8.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In the following description, a ‘message’ refers to data input using a character in a mobile terminal. The message may be an SMS, MMS, E-mail, instant message and the like.

A ‘word’ is formed with characters and may be divided by spaces in order to constitute a message input by a user.

A ‘dictation function’ is a function of analyzing a voice signal input into the mobile terminal and of converting the voice signal into a message consisting of characters. In an exemplary implementation, the dictation function is performed in a message inputting mode of the mobile terminal.

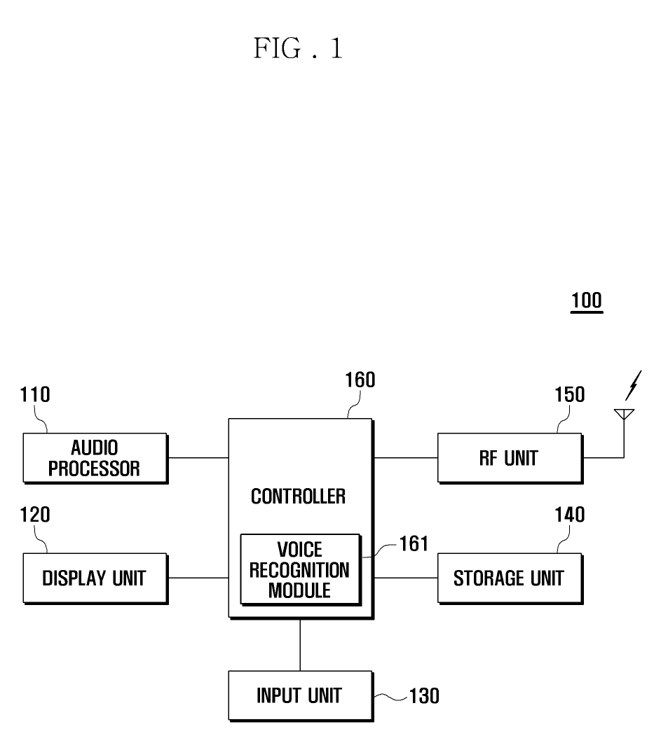

FIG. 1 is a block diagram illustrating a configuration of a mobile terminal according to an exemplary embodiment of the present invention.

Referring to FIG. 1, a mobile terminal 100 includes an audio processor 110, display unit 120, input unit 130, storage unit 140, Radio Frequency (RF) unit 150, and controller 160.

The audio processor 110 receives an audio signal output from the controller 160 and reproduces the audio signal through an audio speaker. In an exemplary implementation, the reproduced audio signal is an audible signal. The audio signal may be, for example, a voice and/or an audible noise. The audio processor 110 also outputs an audio signal generated through a microphone to the controller 160. For example, the audio processor 110 receives a voice signal input through the microphone and outputs the processed voice signal to the controller 160 in a message input mode.

The display unit 120 displays various information related to states and operations of the mobile terminal 100. In an exemplary implementation, the display unit 120 may use a Liquid Crystal Display (LCD). In this case, the display unit 120 may include an LCD controller, a memory that can store image data, and an LCD display element. If the LCD includes a touch screen, the LCD may be used as an input unit, either supplemental to or in place of input unit 130. The display unit 120 may display a message according to an input voice signal in a message input window under the control of the controller 160, input a message, or display a modified message.

The input unit 130 includes input and function keys for inputting numerals and characters and for setting various functions. The input and function keys may include direction keys, side keys, hotkeys and the like for performing specific functions. More particularly, the input unit 130 includes a function key for performing a dictation function in a message input mode. The function key may be a key provided separately from the input unit 130, and may be a key assigned a specific function, such as a camera key. Here, it is assumed that the camera key is a function key for performing a dictation function in the message input mode as well as for performing a camera function. Of course, this is merely for example and another key may also serve to perform a dictation function in the message input mode as well as its additionally assigned function.

The storage unit 140 stores programs for controlling operations of the mobile terminal 100 and stores various data generated when operating the mobile terminal 100. The storage unit 140 stores a user voice model that may be used when inputting a message using a voice signal. The user voice model includes voice data consisting of words and sentences input with a voice by the user and stored in the mobile terminal 100. Further, the storage unit 140 stores message modification instructions for use when modifying or transmitting an input message. Instructions for modifying a message may include ‘search’, ‘modify’, ‘add’, ‘move’, ‘delete’, ‘entire delete’, ‘move to left side’, ‘move to right side’, ‘move to upper side’, ‘move to lower side’ and the like. Further, instructions for transmitting a message may include ‘transmit message’, ‘send’, ‘complete input of message’, ‘complete’ and the like. An instruction for modifying or transmitting a message may be set by a user, or may be preset in a manufacturing process of the mobile terminal.

The RF unit 150 performs a radio frequency communication function between the mobile terminal 100 and a base station. The RF unit 150 includes a duplexer for separating a transmission and reception signal, an RF transmitter for up-converting a frequency of a signal to be transmitted, and an RF receiver for down-converting a frequency of a received signal.

The controller 160 controls operating states of the mobile terminal 100. For example, the controller 160 converts a voice signal into a message using a Sound To Text (STT) function. The STT function is a function of converting an input voice signal into a character when the voice signal is input. In order to perform the STT function, the controller 160 includes a voice recognition module 161. The voice recognition module 161 recognizes a voice signal input through a microphone of the audio processor 110, for example in a dictation mode. A method of recognizing a voice signal may be any of the following methods.

### 1) Speaking Person Dependent Method

In this method, a speaking person can only be a specified preregistered speaking person. A representative example of this method is a voice dialing function of the mobile terminal 100. This method has the best voice recognition performance of the voice analysis methods described herein.

### 2) Speaking Person Independent Method

In this method, a speaking person is an unspecified speaker. Accordingly, in order to find a characteristic of a voice regardless of a characteristic of the speaking person, a large sound database is required. Representative examples of this method are a phone number guidance service generally provided in an Advanced Record System (ARS), a ticket reservation service through voice recognition, and an address input service in an automatic call service.

### 3) Isolated Language Recognition Method

This is a method of recognizing a voice by dividing and reading an isolated word, i.e. each word individually. In this method, because a mute section exists before and after a word, the beginning and the end of the word are easily identified. This method thus has a high recognition rate. A representative example thereof is a voice browser (to execute a specific program using voice recognition, or to move to another site while web surfing).

### 4) Continuous Language Recognition Method

In this method, a connection word, a continuous sentence, and a dialogic voice can be recognized. A language model appropriate for a characteristic of each word together with a reference pattern in consideration of various pronunciation changes is required. A representative example thereof is an interface between user computers such as a voice typewriter, an automatic reservation system, and a dialogic computer.

### 5) Small Quantity Recognition Method

This method is used for several hundred words or fewer, and a voice is recognized by using each word as an individual model or using a context independent type model. A representative example thereof is a personal computer commander (a simple model for controlling a program using voice recognition).

### 6) Large Quantity Recognition Method

This method is used for tens of thousands of words and uses a model having several thousand sub-words type model in consideration of a context. Representative examples thereof are a voice typewriter and a broadcasting news script.

The voice recognition module 161 recognizes a voice signal input through the audio processor 110 using at least one of the above-described voice recognition methods. The controller 160 compares a voice signal recognized by the voice recognition module 161 with a user voice model stored in the storage unit 140. If the recognized voice signal is a voice signal for inputting a message, the controller 160 controls to display the message corresponding to the recognized voice signal in a message input window of the display unit 120. Alternatively, if the recognized voice signal is included in a message modification instruction stored in the storage unit 140, the controller 160 recognizes that the input voice signal is a message modification instruction and modifies the message according to the voice signal.

In the mobile terminal 100, if a dictation function is selected in a message input mode through the input unit 130, the audio processor 110 transmits a voice signal input through the microphone to the controller 160. The controller 160 analyzes the received voice signal, compares the analyzed voice signal with a user voice model and a message modification instruction stored in the storage unit 140, and determines whether the received voice signal is a voice for inputting a message or a signal for modifying the input message. The controller 160 modifies or inputs a message according to the determined voice signal.

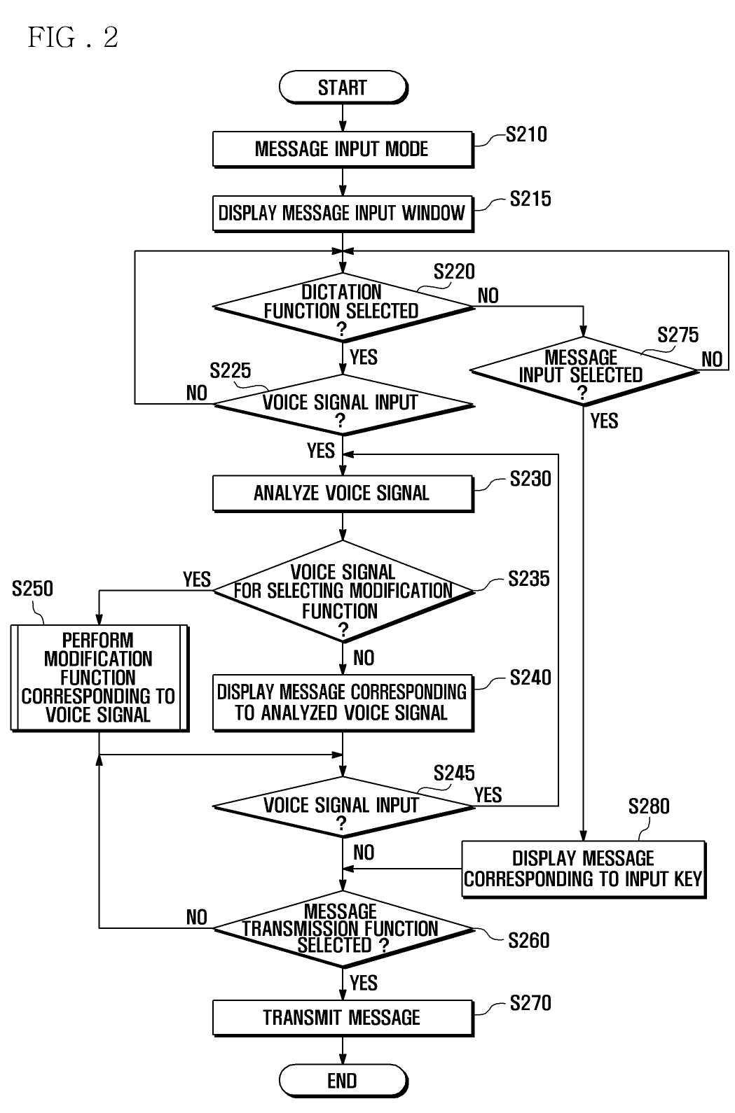

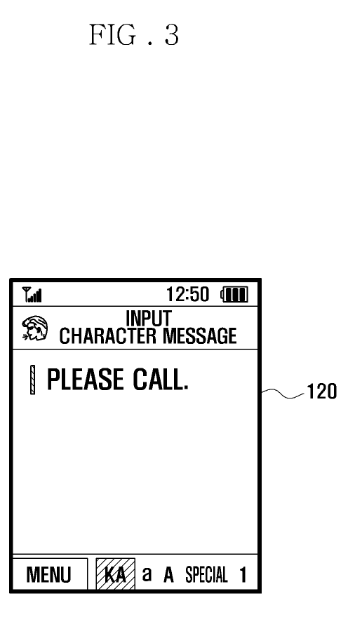

FIG. 2 is a flowchart illustrating a method of inputting a message through voice recognition in a mobile terminal according to an exemplary embodiment of the present invention. FIG. 3 illustrates an example of a screen displaying a message input window in a mobile terminal in the method of FIG. 2.

Referring to FIG. 2, the user selects a message input mode of the mobile terminal 100 using a menu or a function key in order to input a message. The controller 160 detects the user selection and converts a mode of the mobile terminal 100 into a message input mode in step S210.

The controller 160 controls to display a message input window for inputting a message in the display unit 120 in step S215, as illustrated in the screen example of FIG. 3.

The controller 160 determines whether a key for selecting a dictation function is input in step S220.

If a key for selecting a dictation function is input, the controller 160 determines whether a voice signal is input through a microphone of the audio processor 110 in step S225.

If the user inputs a voice signal through a microphone, the controller 160 analyzes the input voice signal in step S230.

The controller 160 determines whether the analyzed voice signal is a voice signal for selecting a modification function in step S235. Specifically, the controller 160 compares a message modification instruction stored in the storage unit 140 with the analyzed voice signal and determines whether the input voice signal is a voice signal for modifying the message.

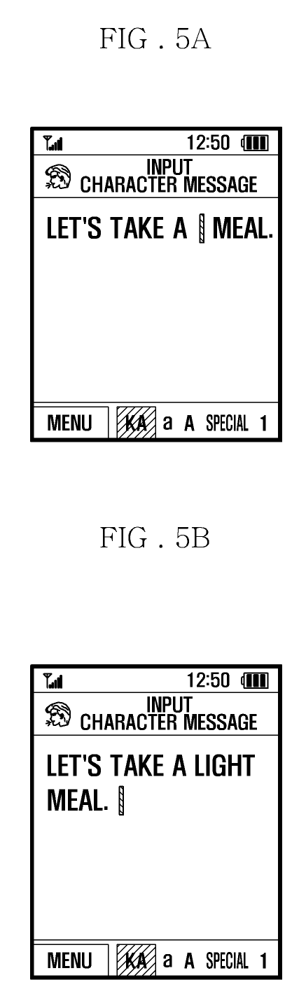

If the analyzed voice signal is not a voice signal for selecting a message modification function, the analyzed voice signal is processed as a signal for inputting a message, and the controller 160 controls to display a message corresponding to the analyzed voice signal in the display unit 120 in step S240. For example, as illustrated in the screen example of FIG. 5A, if the user intends to input a message ‘Let's take a meal’, the user inputs a voice signal ‘Let's take a meal’ through the microphone of the audio processor 110 at step S225. The controller 160 analyzes the voice signal ‘Let's take a meal’ at step S230, and compares the voice signal ‘Let's take a meal’ with a message modification instruction of the storage unit 140 at step S235. If the voice signal ‘Let's take a meal’ is not included as a message modification instruction in the storage unit 140, the controller 160 controls to display the voice signal ‘Let's take a meal’ in a message input window in the display unit 120 at step S240, as illustrated in FIG. 5A. The controller 160 compares the input voice signal with a user voice model stored in the storage unit 140, and if a user voice model corresponding to the input voice signal exists in the storage unit 140, the controller 160 controls to display the input voice signal into a message corresponding to the user voice model.

The controller 160 then determines whether a further voice signal is input in step S245. In an exemplary implementation, the input of the voice signal is determined by whether a camera key is input. In other words, if the user inputs a camera key in a message input mode, the controller 160 determines the input as a voice signal input signal. The controller 160 determines a signal input through the audio processor 110 as a voice signal for inputting a message.

If a further voice signal is input, the process returns to step S230 and the controller 160 analyzes the input voice signal.

If the analyzed voice signal is a voice signal for selecting a modification function at step S235, the controller 160 performs a modification function corresponding to the voice signal in step S250.

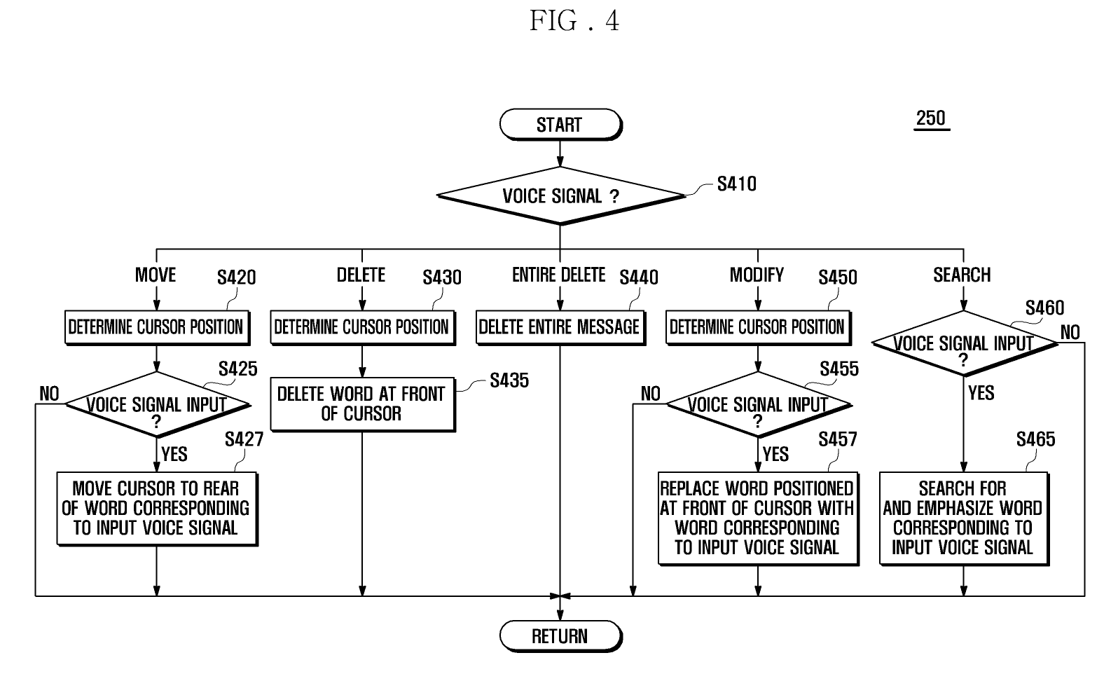

FIG. 4 is a flowchart illustrating an exemplary process of performing a message modification function of step S250 in FIG. 2.

Referring to FIG. 4, the controller 160 identifies the voice signal input for selecting a message modification function in step S410.

If the user intends to move a cursor to modify the input message, the user inputs a voice signal ‘move’ through the audio processor 110. The controller 160 determines whether the input voice signal ‘move’ is included as a message modification instruction stored in the storage unit 140 at step S235. If the input voice signal ‘move’ is included as a message modification instruction stored in the storage unit 140, the controller 160 identifies the input voice signal ‘move’ as a movement instruction at step S410.

The controller 160 determines a cursor position within the displayed message in step S420 and determines whether a further voice signal is input in step S425. If the user inputs a voice signal through the audio processor 110 corresponding to a word in the displayed message, the controller 160 locates the word corresponding to the input voice signal. The controller 160 then moves the cursor to the rear of the word corresponding to the input voice signal in step S427.

If the user intends to delete the input message, the user inputs a voice signal ‘delete’ through the audio processor 110. The controller 160 determines whether the input voice signal ‘delete’ is included as a message modification instruction stored in the storage unit 140 at step S235. If the input voice signal ‘delete’ is included as a message modification instruction in the storage unit 140, the controller 160 identifies the input voice signal ‘delete’ as a deletion instruction at step S410. The controller 160 then determines a cursor position in step S430 and deletes a word at the front of the cursor in step S435. Alternatively, the controller 160 may be configured, for example by programming of the user, to delete the word at the end of the cursor in step S435.

Furthermore, while it is described above that, when the voice signal ‘delete’ is input, a word positioned at the front of the cursor is deleted, characters within a word may also be deleted one by one. Alternatively, instead of deleting a word positioned at the front of the cursor upon inputting the voice signal such as ‘delete’, a word or a character corresponding to a next voice signal input immediately after inputting the voice signal ‘delete’ through the audio processor 110 may be deleted. That is, the user inputs the voice signal ‘delete’ and then inputs a word or a character to be deleted with a voice signal through the audio processor 110. The controller 160 compares the first input voice signal ‘delete’ with a message modification instruction stored in the storage unit 140 and determines the voice signal to be a message modification instruction for deletion, then deletes a message corresponding to the next input voice signal.

If the user intends to delete an entire input message, the user inputs a voice signal such as ‘entire delete’ through the audio processor 110. If the input voice signal ‘entire delete’ is determined to be included as a message modification instruction at step S235, the controller 160 identifies the voice signal as an entire deletion instruction at step S410 and deletes the entire input message according to the input voice signal in step S440.

If the user intends to modify the input word, the user inputs a voice signal such as ‘modify’ through the audio processor 110. If the input voice signal ‘modify’ is determined to be included as a message modification instruction at step S235, the controller 160 identifies the input voice signal ‘modify’ as a modification instruction at step S410.

The controller 160 determines a cursor position in the displayed message and a word positioned at the front of the cursor in step S450.

The controller 160 determines whether a modifying word is input with a voice signal through the audio processor 110 in step S455.

If a modifying word is input with a voice signal through the audio processor 110, the controller 160 determines the modifying word and replaces the word positioned at the front of the cursor with the modifying word corresponding to the input voice signal in step S457. It is described here that, if the modification instruction is input, the controller 160 replaces a word positioned at the front of the cursor with a next input voice signal. However, according to user setting or setting of a mobile terminal manufacturer, a character within a word positioned at the front of the cursor may be replaced with a character input with a voice signal.

If the user intends to search for a word, the user inputs a voice signal such as ‘search’ through the audio processor 110. If the input voice signal ‘search’ is determined to be included as a message modification instruction at step S235, the controller 160 identifies the input voice signal ‘search’ as a search instruction at step S410 and determines whether a voice signal is input through the audio processor 110 in step S460. If a voice signal is input, the controller 160 searches for a word corresponding to the input voice signal in the input message and controls to display the found word with an emphasis such as highlighting in step S465. The controller 160 moves a cursor to the rear of the emphasized word. Although not illustrated in the drawings, if a word corresponding to the input voice signal is not found, the controller 160 controls to display a pop-up window in the display unit 120 informing that the found word does not exist and inquiring whether a re-search is to be performed.

The process of modifying a message through a voice signal in FIG. 4 is described in more detail with reference to screen examples in FIGS. 5A to 7B.

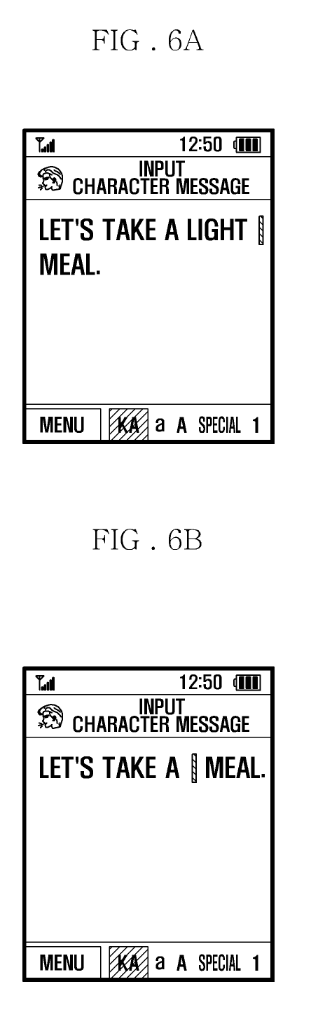

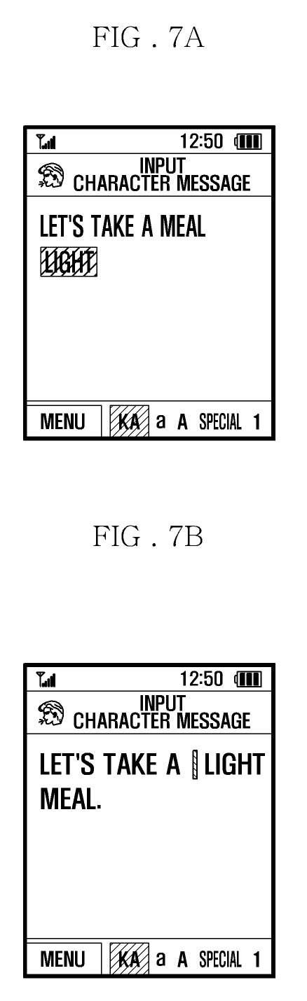

FIGS. 5A and 5B illustrate examples of a screen for adding a word in the process of FIG. 4. FIGS. 6A and 6B illustrate examples of a screen for deleting a word in the process of FIG. 4. FIGS. 7A and 7B illustrate examples of a screen for adding another word after deleting a word in the process of FIG. 4.

A process of modifying a message includes a case of adding a word to a message, for example ‘Let's take a meal’ illustrated in FIG. 5A, to make a message such as ‘Let's take a light meal’ illustrated in FIG. 5B. First, the user should move a cursor positioned at the rear of the sentence ‘Let's take a meal’ to a position between ‘a’ and ‘meal’. The user inputs a camera key, then inputs a voice signal ‘move’ through the audio processor 110, and then inputs a voice signal ‘a’. The controller 160 first analyzes the input voice signal ‘move’ and determines that a cursor movement instruction is input. The controller 160 identifies the next input voice signal ‘a’ and moves the cursor to the rear of the word ‘a’ corresponding to the input voice signal ‘a’, as illustrated in FIG. 5A.

The controller 160 identifies a voice signal ‘light’ input to the audio processor 110 and determines whether the voice signal ‘light’ is included as a message modification instruction stored in the storage unit 140. If the voice signal ‘light’ is not included as a message modification instruction stored in the storage unit 140, the controller 160 determines the voice signal ‘light’ to be a voice signal for inputting a message, and controls the display unit 120 to display ‘light’ at the cursor position. Thereby, the user can modify the message ‘Let's take a meal’ input to the mobile terminal 100 to the message ‘Let's take a light meal’ illustrated in FIG. 5B.

The process of modifying a message further includes a case of deleting an input word in a message, for example ‘Let's take a light meal’ illustrated in FIG. 6A, to make a message such as ‘Let's take a meal’ illustrated in FIG. 6B. The user inputs a camera key and then inputs a voice signal ‘move’ through the audio processor 110. The controller 160 determines that movement of the cursor is selected and determines whether a voice signal is input through the audio processor 110. If the user inputs a voice signal ‘light’ through the audio processor 110, the controller 160 moves the cursor to the rear of the word ‘light’ corresponding to the voice signal ‘light’, as illustrated in FIG. 6A. The user inputs a voice signal ‘delete’ through the audio processor 110. The controller 160 identifies the voice signal ‘delete’, and deletes the word ‘light’ and controls to display the word ‘a’ at the rear of the cursor, as illustrated in FIG. 6B.

The process of modifying a message further includes a case of adding another word after deleting a word in a message, for example ‘Let's take a meal light’ illustrated in FIG. 7A, to make a message such as ‘Let's take a light meal’ illustrated in FIG. 7B. The user inputs a voice signal ‘search’ through the audio processor 110 and then inputs a voice signal ‘light’. The controller 160 determines the voice signal ‘search’ to be a message search instruction, and searches for a word ‘light’ corresponding to the voice signal ‘light’ input after the voice signal ‘search’ in the message. The controller 160 controls to display the found message ‘light’ with emphasis such as highlighting, as shown in FIG. 7A. The user inputs a voice signal ‘delete’ for deleting the found word ‘light’ through the audio processor 110. The controller 160 determines the input voice signal ‘delete’ to be a deletion instruction and deletes the found word ‘light’. A method of searching for and deleting a word is described. However, if a voice signal ‘add’ is input instead of the voice signal ‘delete’, a word may be added at the rear of the found word.

In order to input a word ‘light’, the user should first move the cursor currently positioned at the rear of the word ‘meal’. For this, the user inputs a camera key, then inputs a voice signal ‘move’ through the audio processor 110, and inputs a voice signal ‘a’ corresponding to a position at the rear of the word ‘a’ to which the cursor is to moved. The controller 160 determines that a movement instruction for changing the cursor position is selected and moves the cursor to the rear of the word ‘a’. The user then inputs a voice signal ‘light’ through the audio processor 110, and the controller 160 determines the voice signal ‘light’ to be a voice signal for inputting a message and controls to display the input voice signal ‘light’ in the message input window, as illustrated in FIG. 7B. As an alternative to deleting a word and adding the same word at another position in the message, the controller 160 may move the found message ‘light’ to the rear of the word ‘a’ through a voice signal word ‘move’.

Here, movement of a cursor indicates that the cursor is moved to the rear of a word corresponding to a voice signal input after a voice signal ‘move’. Further, movement of a cursor may indicate a method of inputting a voice signal according to a direction for the user to move the cursor. For example, if the user inputs a voice signal ‘move to the left side’ through the audio processor 110, the controller 160 detects the input voice signal and moves the cursor positioned at the rear of a word ‘meal’, as illustrated in FIG. 5A, to a position between a word ‘a’ and the word ‘meal’. In this case, the cursor may be moved to a position between words, and may be moved to a position between characters.

At step S235 of determining whether the input voice signal is a voice signal for modifying a message, the controller 160 analyzes the input voice signal, compares the input voice signal with a message modification instruction stored in the storage unit 140, and thereby determines whether the input voice signal is a voice signal for modifying a message. Further, if a function key for modifying a message in the input unit 130 is input, or if a user, for example, inputs a voice signal after quickly inputting a dictation key twice, the controller 160 may determine the function key input or the voice signal as a signal for modifying a message.

Returning to FIG. 2, after performing a modification function corresponding to the voice signal at step S250, the process continues at step S245 and the controller 160 determines whether a further voice signal is input.

If a further voice signal is not input at step S245, the controller 160 determines whether a message transmission function is selected in step S260. Here, if the user inputs a voice signal ‘message transmission’ through the audio processor 110, the controller 160 analyzes the voice signal and determines that message transmission is selected. Alternatively, if the user selects message transmission using a menu or a function key provided in the input unit 130, the controller 160 determines that message transmission is selected.

If message transmission is selected, the controller 160 controls to display an input window for inputting a phone number to which the message is to be transmitted in the display unit 120. This process may be omitted when a phone number to which the message is to be transmitted is previously input. When the user inputs the phone number to the input window, the controller 160 transmits the message to the input phone number using the RF unit 150 in step S270. The user may input the phone number through a key provided in the input unit 130 or may input the phone number with a voice signal through the audio processor 110.

A method of inputting a message by inputting a voice signal after inputting a key for selecting a dictation function at step S220 is described. If a key for selecting a dictation function is not input at step S220, the controller determines whether the user inputs a key for message input in step S275. If the user inputs a key for message input through the input unit 130, the controller 160 controls to display a message corresponding to the input key in step S280. Further, if a key is input through the input unit 130, even if a voice signal is input, the controller 160 performs a function corresponding to the input key or controls to display a character.

The controller 160 determines whether a dictation function is selected at step S220 according to the input of a camera key. That is, whenever a camera key provided in the input unit 130 is input, the controller 160 determines that a dictation function is selected, analyzes a voice signal input through the audio processor 110, and controls to display the input voice signal as a message in the display unit 120. However, when a key for inputting a message is input instead of inputting a camera key, even if a message is then input through a voice signal, the controller 160 controls to display a message corresponding to the input key.

If a camera key is input through the input unit 130, the controller 160 detects that a dictation function is selected and controls to display that a dictation function is selected using an icon, as illustrated in FIG. 3 in the message input window. In the description above, the dictation function is selected by the input of a camera key, however the dictation function may also be selected using a menu.

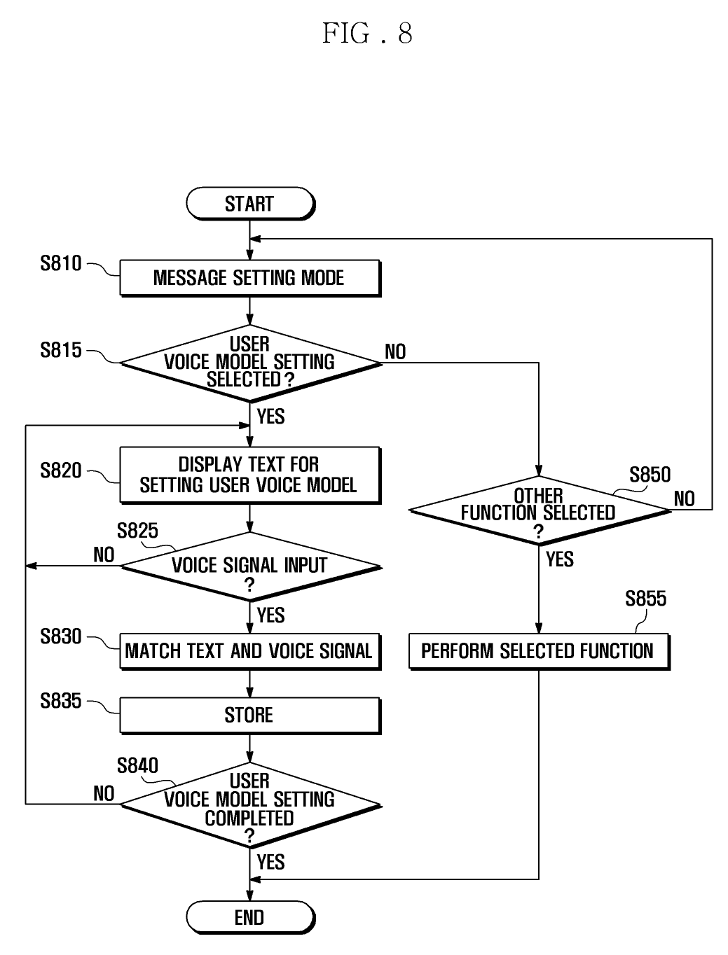

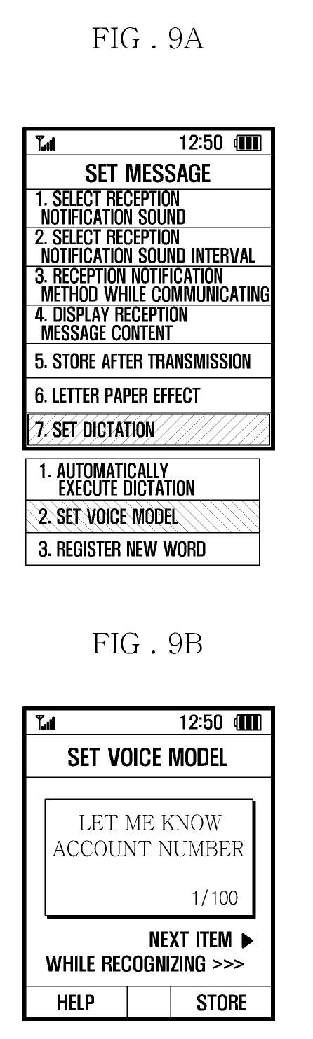

FIG. 8 is a flowchart illustrating a method of setting a user voice model in a mobile terminal according to an exemplary embodiment of the present invention. FIGS. 9A and 9B illustrate examples of a screen for setting the user voice model in the method of FIG. 8.

Referring to FIG. 8, when the user selects a message setting mode through a menu or a function key, the controller 160 sets a mode of the mobile terminal 100 to the message setting mode in step S810. The controller 160 controls to display functions included in the message setting mode, as illustrated in FIG. 9A.

The controller 160 determines whether a user voice model setting is selected by the user through the input unit 130 in step S815.

If a user voice model setting is selected by the user through the input unit 130, the controller 160 controls to display a text for setting the user voice model in step S820, as illustrated in FIG. 9B.

The controller 160 determines whether a voice signal is input through the audio processor 110 in step S825.

If a voice signal is input through the audio processor 110, the controller 160 controls to match the text and the voice signal in step S830 and stores the corresponding text and voice signal in step S835. For example, the controller 160 controls the display unit 120 to display a text ‘Let me know an account number’, as illustrated in FIG. 9B. The user then reads the displayed text ‘Let me know an account number’ and inputs the text as a spoken voice signal ‘Let me know an account number’ through the microphone of the audio processor 110. The controller 160 detects the voice signal, matches the displayed text ‘Let me know an account number’ and the voice signal ‘Let me know an account number’, and stores the displayed text and the corresponding voice signal as a user voice model in the storage unit 140. Here, several texts for setting a user voice model may exist, and the texts may be set by the user, preset upon manufacture of the mobile terminal 100, downloaded from a server and the like.

The controller 160 determines whether the user voice model setting is completed in step S840.

In order to confirm that a user voice model setting is completed, the user inputs a function key provided thereto in the input unit 130 and the controller 160 recognizes the input as completion of the user voice model setting. Further, if voice signals corresponding to all texts within a textbook for setting the user voice model are input, the controller 160 may recognize the input as completion of the user voice model setting. If the user voice model setting is completed, the controller 160 terminates the user voice model setting.

If a user voice model setting is not selected by the user through the input unit 130 at step 815, the controller 160 determines whether another function is selected in step S850. For example, another function may be selection of a reception notification sound and selection of a reception notification sound interval, as illustrated in FIG. 9A. If the user selects another function to perform through the input unit 130, the controller 160 performs the selected function in step S855.

In the mobile terminal 100, in addition to a method of setting a user voice model using a sentence, a user voice model may be set using a word. Specifically, the user inputs a word through the input unit 130, then inputs a voice signal corresponding to the word through the audio processor 110. The controller 160 detects the input, matches the word input through the input unit 130 and the voice signal input through the audio processor 110, and stores the input word and the corresponding voice signal in the storage unit 140. Further, the user may store a special character with a voice signal in the mobile terminal 100, in order to enable input of the special character using a voice signal when inputting a message. For example, a special character ‘%’ may be stored with a corresponding voice signal ‘percent’, a special character ‘?’ may be stored with a corresponding voice signal ‘question mark’, and a special character ‘!’ may be stored with a corresponding voice signal ‘exclamation mark’. When the user inputs a voice signal corresponding to a special character when inputting a message, the controller 160 detects the input and controls to display the special character corresponding to the input voice signal in the display unit 120. The method of setting a user voice model may also be used to set a voice signal corresponding to a message modification instruction necessary for modifying a message. When the mobile terminal has a menu for setting a message modification instruction, if the user selects the message modification instruction setting menu, the controller 160 controls to display an input window for setting a message modification instruction. The user selects an instruction from the setting menu, for example ‘move a cursor’ necessary for moving a cursor, then inputs the instruction ‘move a cursor’ using a voice. The controller 160 matches the voice signal ‘move a cursor’ with the corresponding message modification instruction and stores the instruction with the corresponding voice signal in the storage unit 140. Subsequently, whenever the user inputs the voice signal ‘move a cursor’, the controller 160 compares the voice signal ‘move a cursor’ with a message modification instruction, and determines that the message modification instruction ‘move a cursor’ is selected.

Further, when the mobile terminal is in a silent mode, if the user selects the input of a message through the input of a voice, the controller 160 controls to display whether the silent mode is released using a pop-up window. Accordingly, in a silent mode of the mobile terminal, the controller 160 may determine the input of a message through the input of a voice signal of the user.

As described above, according to exemplary embodiments of the present invention, when inputting a message in a mobile terminal, a user can input a message using a voice without using an input unit. Further, when modifying a message, the user can control movement of a cursor using a voice and modify the message. The user can search for and modify a word in the message using a voice. Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims and their equivalents.

What is claimed is:

1. A method of inputting a message in a mobile terminal having a function of converting a voice signal into a character, the method comprising:
analyzing an input voice signal and determining whether the voice signal corresponds to a message modification instruction; and
modifying, if the voice signal corresponds to a message modification instruction, a message according to the voice signal.

2. The method of claim 1, wherein the message modification instruction comprises at least one of ‘move’, ‘delete’, ‘entire delete’, ‘modify’, and ‘search’.

3. The method of claim 2, wherein the modifying of the message according to the voice signal comprises:
determining, if the voice signal comprises a ‘move’ instruction, a position of a cursor; and
if a next voice signal is input, moving the cursor to the rear of a word in the message corresponding to the next voice signal.

4. The method of claim 3, wherein the modifying of the message according to the voice signal comprises:
determining, if the voice signal comprises a ‘modify’ instruction, a position of the cursor; and
if a next voice signal is input, replacing a word positioned at the front of the cursor with a word corresponding to the next voice signal.

5. The method of claim 2, wherein the modifying of the message according to the voice signal comprises:
determining, if the voice signal comprises a ‘search’ instruction, whether a next voice signal is input;
searching for a word in the message corresponding to the next voice signal; and
if the word is found, displaying the found word.

6. The method of claim 5, wherein the displaying of the found word comprises displaying the found word in highlight.

7. The method of claim 3, wherein the modifying of the message according to the voice signal comprises:
determining, if the voice signal comprises a ‘delete’ instruction, a position of the cursor; and
deleting a word positioned at the front of the cursor.

8. The method of claim 1, further comprising:
determining, if a dictation key comprises input, whether a voice signal is input; and
if a voice signal is input, analyzing the input voice signal.

9. The method of claim 1, further comprising displaying, if the voice signal does not correspond to a message modification instruction, a message corresponding to the voice signal.

10. A method of inputting a message of a mobile terminal having a function of converting a voice signal into a character, the method comprising:
setting a voice signal for instructing movement of a cursor;
determining, if the voice signal for instructing movement of a cursor is input in a message input mode, whether a next voice signal is input; and
moving, if a next voice signal is input, the cursor to a word of a message corresponding to the next voice signal.

11. A method of inputting a message in a mobile terminal having a function of converting a voice signal into a character, the method comprising:
setting a voice signal for deleting a word included in an input message;
determining, if a voice signal for deleting a word is input in a message input mode, whether a next voice signal is input; and
if a next voice signal is input, deleting a word in the message corresponding to the next voice signal.

12. A mobile terminal, the terminal comprising:
an input unit;
an audio processor for receiving a voice signal;
a display unit for displaying a message corresponding to the input voice signal; and
a controller for analyzing the voice signal input through the audio processor, for determining whether the voice signal is a voice signal for modifying a message, for displaying, if the voice signal is not a voice signal for modifying a message, a message according to the voice signal and for modifying, if the voice signal is a voice signal for modifying a message, a message according to the voice signal.

13. The terminal of claim 12, wherein the input unit comprises a dictation key and further wherein the audio processor receives the voice signal when the dictation key is input and the controller analyzes the voice signal if the dictation key is input.

14. The terminal of claim 13, further comprising a storage unit for storing a message modification instruction,
wherein the controller determines, if the voice signal corresponds to a message modification instruction stored in the storage unit, the voice signal as a voice signal for modifying a message.

15. The terminal of claim 14, wherein the message modification instruction comprises at least one of ‘move’, ‘delete’, ‘entire delete’, ‘modify’, and ‘search’.

16. The terminal of claim 15, wherein the controller determines, if the analyzed voice signal comprises a ‘move’ instruction, a position of a cursor and moves, if a next voice signal is input, the cursor to the rear of a word in the message corresponding to the next voice signal.

17. The terminal of claim 16, wherein the controller determines, if the analyzed voice signal comprises a ‘modify’ instruction, a position of the cursor and replaces, if a next voice signal is input, a word positioned at the front of the cursor with a word corresponding to the next voice signal.

18. The terminal of claim 15, wherein the controller controls to search for, if the analyzed voice signal comprises a ‘search’ instruction and a next voice signal is input, a word in the message corresponding to the next voice signal, and to display, if the word is found, the found word.

19. The terminal of claim 18, wherein the controller controls to display the found word in highlight.

20. The terminal of claim 18, wherein the controller determines, if the analyzed voice signal comprises a ‘delete’ instruction, a position of the cursor and deletes a word positioned at the front of the cursor.
